(19) United States
(12) Patent Application Publication
(10) Pub. No.: US 2012/0134315 A1
(43) Pub. Date: May 31, 2012

(54) APPARATUS AND METHOD FOR REPORTING PERFORMANCE

(75) Inventor: Sung Jin HONG, Hwaseong-si (KR)

(73) Assignee: PANTECH CO., LTD., Seoul (KR)

(21) Appl. No.: 13/196,787

(22) Filed: Aug. 2, 2011

(30) Foreign Application Priority Data
Nov. 29, 2010 (KR) 10-2010-0119798

(51) Int. Cl. H04W 24/00; H04W 88/04

(52) U.S. Cl. 370/315; 370/328

(57) ABSTRACT

Provided are different wireless communication systems, in particular, a method and an apparatus for reporting performance between wireless communication systems. Information about a wireless network in an area where wireless communication systems coexist may be shared, through recognizing performance degradation of a wireless communication service provided by a first wireless communication system, and transmitting performance information of the wireless communication service provided by the first wireless communication system to a second wireless communication system.

### CROSS-REFERENCE TO RELATED APPLICATION

This application claims priority from and the benefit under 35 U.S.C. §119(a) of Korean Patent Application No. 10-2010-0119798, filed on Nov. 29, 2010, which is hereby incorporated by reference for all purposes as if fully set forth herein.

### BACKGROUND

1. FIELD

Exemplary embodiments of the present invention relate to wireless communication systems, and more particularly, to a method and an apparatus for reporting the performance of different wireless communication systems.

2. Discussion of the Background

Wireless communication systems have become high-speed, stable, and intelligent. With the development and the subdivision of the wireless communication system, a terminal may receive a wireless communication service in an area where different wireless communication systems coexist. In this instance, if performance degradation or discontinuation of the wireless communication service occurs, the terminal may cut off a connection with an existing wireless communication system from which the terminal is receiving the wireless communication service, and may attempt to connect to a new wireless communication system.

Accordingly, a user may suffer from discontinuance of a service in an area where different wireless communication systems coexist.

Also, conventionally, because a condition of a service for a terminal is not transmitted between different wireless communication systems, sharing of information about a wireless network may be limited.

### SUMMARY OF THE INVENTION

Exemplary embodiments of the present invention provide a method and an apparatus for reporting performance, which may share information about a wireless network in an area where wireless communication systems coexist.

Exemplary embodiments of the present invention also provide a method and an apparatus for reporting performance, which may recognize a movement of a terminal by sharing information about a wireless network in an area where wireless communication systems coexist.

Exemplary embodiments of the present invention also provide a method and an apparatus for reporting performance, which may collect information about a non-service area by sharing information about a wireless network in area where wireless communication systems coexist.

Exemplary embodiments of the present invention also provide a method and an apparatus for reporting performance, which may take a specific action in real time by collecting information about a non-service area.

Additional features of the invention will be set forth in the description which follows, and in part will be apparent from the description, or may be learned by practice of the invention.

An exemplary embodiment of the present invention discloses a method for reporting performance in a terminal, including receiving a wireless communication service from a first wireless communication system, recognizing performance degradation of the wireless communication service provided by the first wireless communication system; transmitting performance information of the wireless communication service to a second wireless communication system; and determining whether an accessible relay exists among relays included in the first wireless communication system.

An exemplary embodiment of the present invention also discloses a method for reporting performance in a first wireless communication system, including receiving performance information of a wireless communication service provided by a second wireless communication system to a terminal, wherein the terminal receives the wireless communication service from the second wireless communication system; and transmitting the received performance information to the second wireless communication system, wherein the performance information may include at least one of location information of the terminal, a received field strength, service quality information, and identity information of a relay around the terminal.

An exemplary embodiment of the present invention also discloses an apparatus to report performance information, including a first performance information obtaining unit to obtain performance information of a wireless communication service provided by a first wireless communication system; a recognition unit to recognize performance degradation of the wireless communication service provided by the first wireless communication system; a communication unit to transmit the performance information of the wireless communication service to a second wireless communication system; and a control unit to determine whether an accessible relay exists among relays included in the first wireless communication system.

An exemplary embodiment of the present invention also discloses an apparatus to report performance, including a first communication unit to receive performance information of a wireless communication service provided by a first wireless communication system to a terminal, wherein the terminal received the wireless communication service from the first wireless communication system; a control unit to check a management apparatus of the first wireless communication system based on the received performance information, and a second communication unit to transmit the received performance information to a management apparatus of the first wireless communication system.

An exemplary embodiment of the present invention also discloses an apparatus to receive performance, including a performance information receiving unit to receive, from the second wireless communication system, performance information of a wireless communication service provided by a first wireless communication system to a terminal; a control unit to obtain information about a non-service area of the first wireless communication system based on the received performance information; and a database to store the information about the non-service area of the first wireless communication system.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating a wireless communication network environment to which a method for performance reporting is applied according to an exemplary embodiment.

FIG. 2 is a flowchart illustrating a method for performance reporting according to an exemplary embodiment.

FIG. 3 is a block diagram illustrating a performance reporting apparatus according to an exemplary embodiment.

FIG. 4 is a flowchart illustrating a method for performance reporting in a terminal according to an exemplary embodiment.

FIG. 5 is a block diagram illustrating a performance reporting apparatus according to an exemplary embodiment.

FIG. 6 is a flowchart illustrating a method for performance reporting in a wireless communication system according to an exemplary embodiment.

FIG. 7 is a block diagram illustrating a performance receiving apparatus according to an exemplary embodiment.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, if an element is referred to as being “directly connected to” another element, there are no intervening elements present. Further, it will be understood that for the purposes of this disclosure, “at least one of”, and similar language, will be interpreted to indicate any combination of the enumerated elements following the respective language, including combinations of multiples of the enumerated elements. For example, “at least one of X, Y, and Z” will be construed to indicate X only, Y only, Z only, or any combination of two or more items X, Y, and Z (e.g., XYZ, XZ, YZ).

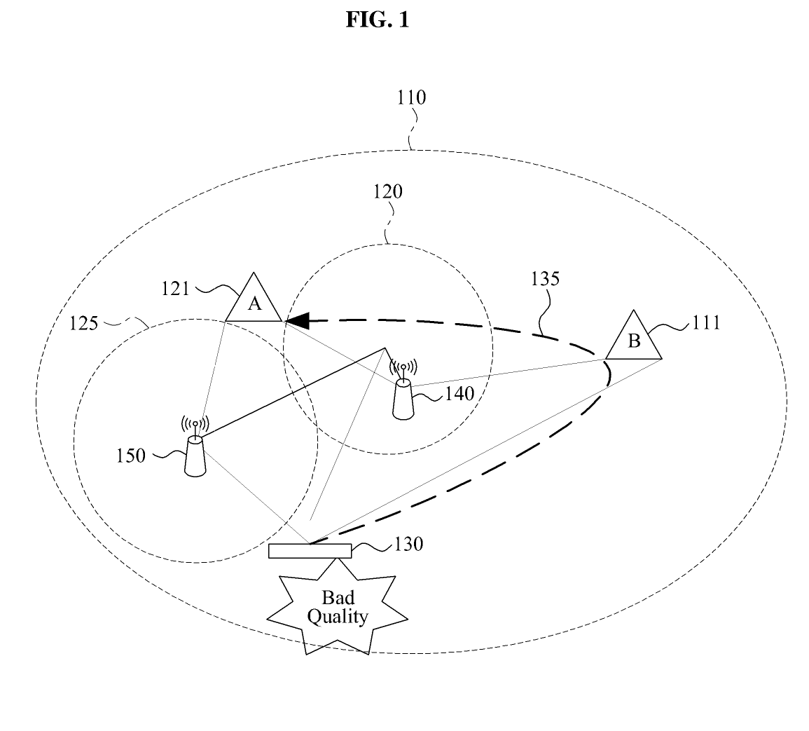

FIG. 1 is a view illustrating a wireless communication network environment to which a method for performance reporting is applied according to an exemplary embodiment.

In FIG. 1, a relay 140 and a relay 150 may provide a terminal 130 with a wireless communication service provided by a first wireless communication system. The wireless communication service may be, for example, a voice communication service, a data communication service, or a combination thereof. The relay 140 may be set to be accessible without limits, and the relay 150 may be set to be accessible through authentication. At least one of the relay 140 and the relay 150 may be a communication apparatus to provide a wireless access service, such as Wi-Fi®. In other words, the first wireless communication system may be a wireless local area network interface according to the IEEE 802.11 and Wi-Fi® standards. Referring to FIG. 1, a coverage 120 of the relay 140 and a coverage 125 of the relay 150 are illustrated. In FIG. 1, a management apparatus A 121 may control and manage the first wireless communication system.

A second wireless communication system is different from the first wireless communication system, and the first wireless communication system and second wireless communication system may coexist in an area. In an exemplary embodiment, the first wireless communication system or second wireless communication system may provide a wireless communication and/or a data service to the terminal 130 through at least one relay.

In FIG. 1, management apparatus B 111 may be a control and manage the second wireless communication system. The second wireless communication system may be a broadband wireless communication system according to the IEEE 802.16 standards. In an exemplary embodiment, the broadband wireless communication system may be based on a Wireless Broadband (WiBro®) scheme, a Worldwide Interoperability for Microwave Access (WiMax®) scheme, or a 3rd Generation Partnership Project (3GPP®) scheme. Referring to FIG. 1, a coverage 110 of the second wireless communication system is illustrated.

If the terminal 130 moves, for example, along a path 135 while the terminal 130 is receiving a wireless communication service from the relay 140 or the relay 150, a wireless communication service may not be suitably provided to the terminal 130 at all locations on the path. If the second communication system is unaware about the service provided to the terminal 130, the terminal 130 may cut off the connection with the first wireless communication system and may attempt to access the second wireless communication system. According to aspects of the present invention, a method for sharing performance information of a wireless communication service provided to the terminal 130 between different wireless communication systems may be provided. The performance information may be information related to performance of a wireless communication service provided to the terminal 130. In an exemplary embodiment, the performance information may include location information of the terminal 130. In an exemplary embodiment, the performance information may include identity information of a relay that is providing a wireless communication service to the terminal 130. In an exemplary embodiment, the performance information may include a received field strength, a data transmission rate, and a service quality of a relay that is providing a wireless communication service to the terminal 130. In other words, the performance information may include geographic information or technical information as well as information related to performance.

Hereinafter, a method for sharing performance information related to the first wireless communication system with the second wireless communication system is described. Similarly, in an exemplary embodiment, performance information related to the second wireless communication system may be shared with the first wireless communication system.

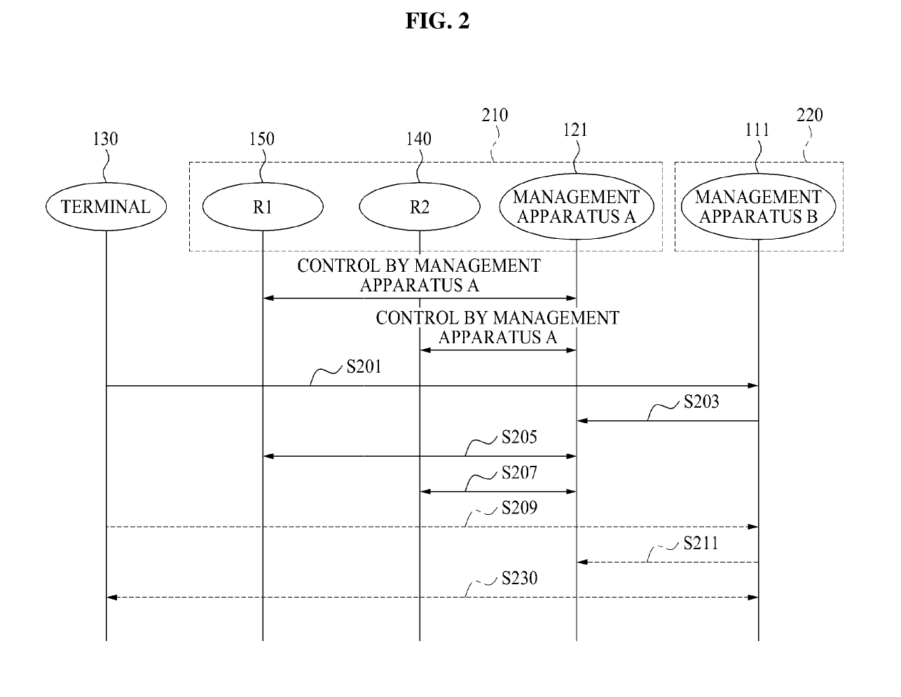

FIG. 2 is a signal flowchart illustrating a method for performance reporting according to an exemplary embodiment.

Referring to FIG. 2, the first wireless communication system 210 may include a relay 140, a relay 150 and the management apparatus A 121. The relays 140 and 150 may be wireless access points (AP) for providing a wireless communication and/or data service. In an exemplary embodiment, the relays 140 and 150 may be a small base station or a femto base station. The management apparatus A 121 may generally manage a network of the first wireless communication system 210 and/or may control an operating system of the relays 140 and 150.

The second wireless communication system 220 may include the management apparatus B 111. Referring to FIG. 1 and FIG. 2, the second wireless communication system 220 may further include at least one base station that may be controlled by the management apparatus B 111.

In FIG. 1 and FIG. 2, the terminal 130 receives a service from the first wireless communication system 210, and is also accessible to the second wireless communication system 220.

The terms, connected to a wireless communication system and access a wireless communication system may describe receiving a data communication service using an allocated radio resource in a corresponding wireless communication system. Hereinafter, for ease of description, a wireless communication service provided by a first wireless communication system is referred to as a first wireless communication service.

In operation S201, the terminal 130 may transmit performance information of a wireless communication service provided by the first wireless communication system 210 to the second wireless communication system 220. The performance information may be transmitted from the terminal 130 to the management apparatus B 111. However, for ease of description, the performance information is described as being transmitted from the terminal 130 to the second wireless communication system 220. The terminal 130 may transmit performance information to the second wireless communication system 220 if performance degradation of the first wireless communication service corresponds to a condition, as described below. The second wireless communication system 220 may recognize that the terminal 130 is not suitably receiving a service based on the performance information received from the terminal 130.

In operation S203, the second wireless communication system 220 may transmit the performance information received from the terminal 130 to the first wireless communication system 210. The transmission of the performance information may be performed from the management apparatus B 111 to the management apparatus A 121. Accordingly, the management apparatus A 121 may recognize the state of a network substantially in real time based on the received performance information. Depending on conditions, in operation S205 or operation S207, the relay 140 or the relay 150 may increase transmission power, respectively. Through operation S201 and operation S203, each different wireless communication system 210 and 220 may recognize a movement of the terminal 130. In an exemplary embodiment, through operation S201, the management apparatus A 121 may collect information about a non-service area based on the performance information.

In operation S209, the terminal 130 may also transmit new performance information to the second wireless communication system 220. The new performance information may include information indicating that the terminal 130 was re-connected to the relay 140 or the relay 150. If the terminal 130 re-enters a coverage 120 of the relay 140 or a coverage 125 of the relay 150, the new performance information may be transmitted to the second wireless communication system 220 as described in detail below. In an exemplary embodiment, if a coverage 120 of the relay 140 or a coverage 125 of the relay 150 is extended, the new performance information may be transmitted to the second wireless communication system 220.

In operation S211, the second wireless communication system 220 may transmit the new performance information to the first wireless communication system 210.

If an accessible relay does not exist in the first wireless system 210 or if a user wants to access the second wireless communication system 220, the terminal 130 may be connected to the second wireless communication system 220, in operation S230.

In FIG. 2, a channel may be provided, via which information about a wireless network may be shared through the terminal 130, by the management apparatus B 111 and/or the management apparatus A 121.

In an exemplary embodiment, performance information related to the second wireless communication system 220 may be shared with the first wireless communication system 210. For example, the terminal 130 may recognize performance degradation of a wireless communication service provided by the second wireless communication system 220, and may transmit information about the recognized performance degradation to the management apparatus B 111 through the first wireless communication system 210.

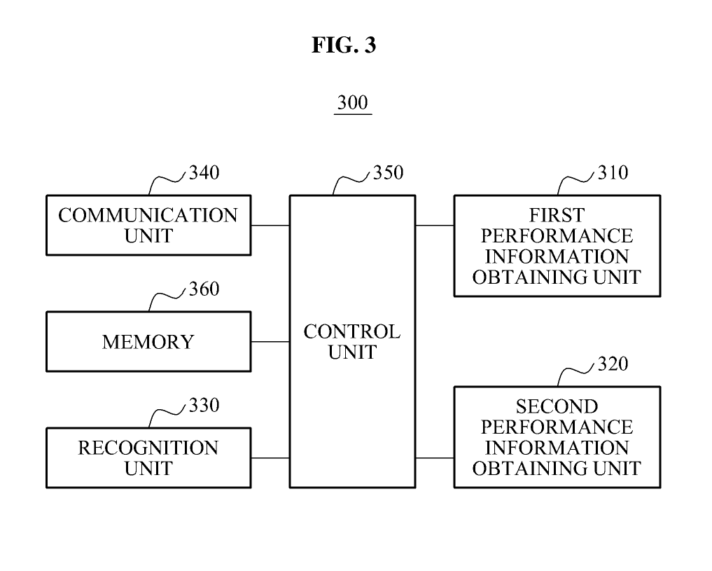

FIG. 3 is a block diagram illustrating a performance reporting apparatus according to an exemplary embodiment. In an exemplary embodiment, the performance reporting apparatus 300 of FIG. 3 may be the terminal 130.

Referring to FIG. 3, the performance reporting apparatus 300, according to an exemplary embodiment, may include a first performance information obtaining unit 310, a recognition unit 330, a communication unit 340, and a control unit 350. In an exemplary embodiment, the performance reporting apparatus 300 may further include a second performance information obtaining unit 320 and a memory 360. In an exemplary embodiment, the first performance information obtaining unit 310 and the second performance information obtaining unit 320 may be combined into a single performance information obtaining unit.

The first performance information obtaining unit 310 may obtain performance information of a first wireless communication service. In other words, the first performance information obtaining unit 310 may obtain performance information of a wireless communication service provided by a first wireless communication system. The first performance information obtaining unit 310 may obtain performance information of a first wireless communication service at regular intervals of time. In an exemplary embodiment, the first performance information obtaining unit 310 may periodically obtain performance information of a first wireless communication service. The performance information may include at least one of location information of a terminal, a received field strength, service quality information, and identity information of a relay. The identity information of a relay may be identity information of a relay from which a terminal is currently receiving a service or may be identity information of a preceding relay from which a terminal received a service.

The second performance information obtaining unit 320 may obtain performance information of a wireless communication service that may be provided by a second wireless communication system. Hereinafter, for ease of description, performance information of a wireless communication service that may be provided by a second wireless communication system is referred to as second performance information. The second performance information obtaining unit 320 may obtain the second performance information at regular intervals of time. In an exemplary embodiment, the second performance information obtaining unit 320 may periodically obtain the second performance information.

The recognition unit 330 may recognize performance degradation of a first wireless communication service. In an exemplary embodiment, the recognition unit 330 may recognize performance degradation of a wireless communication service provided by a second wireless communication system. The recognition unit 330 may recognize performance degradation of a first wireless communication service based on a transmission rate, a received field strength, service quality information of a data service, or combinations thereof provided by a first wireless communication system. For example, if a data transmission rate is smaller than a specific rate, the recognition unit 330 may determine that performance degradation of the first wireless communication service occurred.

The communication unit 340 may transmit performance information of a first wireless communication service to a second wireless communication system. In an exemplary embodiment, the communication unit 340 may transmit second performance information to a first wireless communication system.

The control unit 350 may determine whether an accessible relay exists among relays included in a first wireless communication system. The control unit 350 may include at least one processor configured to control the entire operation of the performance reporting apparatus 300. In an exemplary embodiment, if a received field strength of a current serving relay is smaller than a specific value, the control unit 350 may generate performance information including at least one of location information of a terminal, the received field strength, service quality information, and identity information of the relay. In an exemplary embodiment, the specific value may be determined prior to or contemporaneous with the generation of the performance information. The control unit 350 may control the communication unit 340 to transmit the generated performance information to a second wireless communication system. In an exemplary embodiment, if an accessible relay exists among relays included in the first wireless communication system, the control unit 350 may generate performance information including identity information of the accessible relay. The control unit 350 may control the communication unit 340 to transmit performance information including the identity information of the accessible relay to the second wireless communication system. In an exemplary embodiment, if an accessible relay does not exist among relays included in the first wireless communication system, the control unit 350 may output a message inquiring whether to access the second wireless communication system. The message inquiring whether to access the second wireless communication system may be provided to a user in the form of a voice message or a text message.

The memory 360 may periodically update performance information of a first wireless communication service and second performance information. Accordingly, the performance information transmitted through the communication unit 340 may be the most recently obtained performance information.

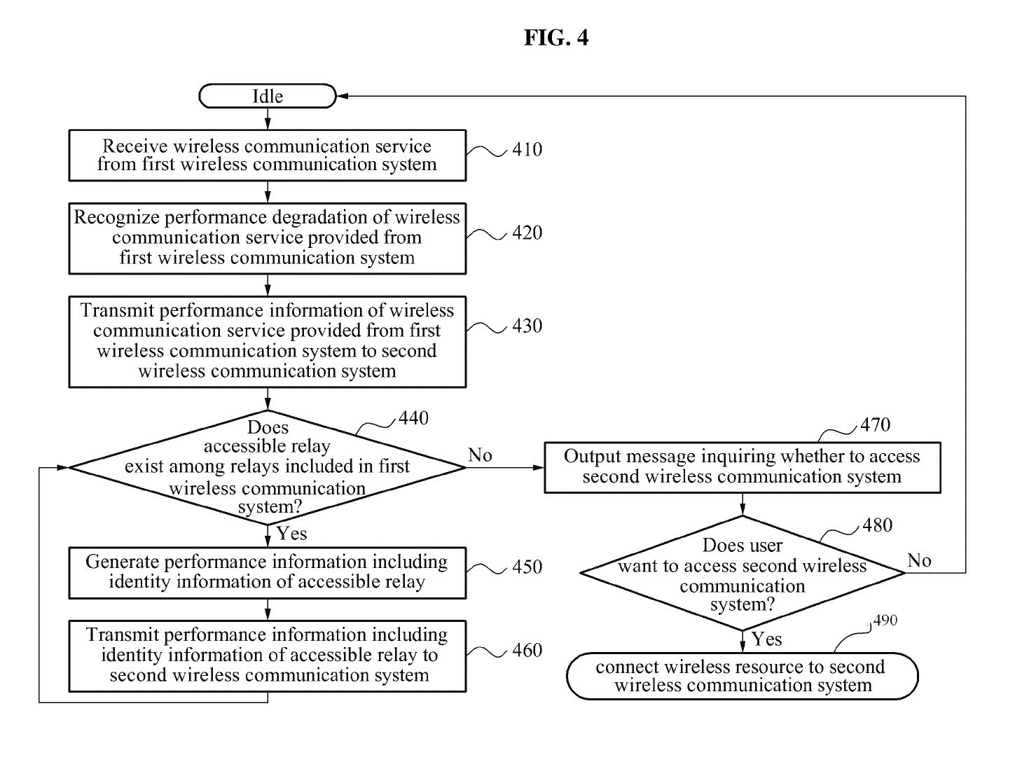

FIG. 4 is a flowchart illustrating a method for performance reporting in a terminal according to an exemplary embodiment. In exemplary embodiments, the method of FIG. 4 may be performed by the terminal 130 or the performance reporting apparatus 300 of FIG. 3.

Referring to FIG. 4, in operation 410, the terminal may receive a wireless communication service from a first wireless communication system. In operation 410, the terminal may be accessible to a second wireless communication system, and may periodically obtain performance information of a first wireless communication service. In other words, in operation 410, the terminal may obtain performance information of a wireless communication service provided from a first wireless communication system. In an exemplary embodiment, in operation 410, the terminal may obtain performance information of a wireless communication service that may be provided by a second wireless communication system. In an exemplary embodiment, in operation 410, the terminal may maintain the performance information of the wireless communication service provided from the first wireless communication system and the performance information of the wireless communication service that may be provided by the second wireless communication system in a memory.

In operation 420, the terminal may recognize performance degradation of the first wireless communication service. In other words, the terminal may recognize performance degradation of the wireless communication service provided from the first wireless communication system. In operation 420, the terminal may recognize performance degradation of the first wireless communication service based on a transmission rate, a received field strength, service quality information of a data service, or combinations thereof provided by the first wireless communication system.

In operation 430, the terminal may transmit the performance information of the wireless communication service provided by the first wireless communication system to the second wireless communication system. In operation 430, the terminal may determine whether a received field strength of a relay of the first wireless communication system is smaller than a specific value. If a received field strength of a relay of the first wireless communication system is smaller than the specific value, the terminal may generate performance information. The terminal may transmit the generated performance information to the second wireless communication system. The performance information may include location information of the terminal, the received field strength, service quality information, identity information of the relay, etc.

In operation 440, the terminal may determine whether an accessible relay exists among relays included in the first wireless communication system.

If an accessible relay exists among relays included in the first wireless communication system, the terminal may transmit new performance information to the second wireless communication system. In other words, in operation 450, the terminal may generate new performance information including identity information of the accessible relay.

In operation 460, the terminal may transmit the performance information including identity information of the accessible relay to the second wireless communication system.

If an accessible relay does not exist among relays included in the first wireless communication system, the terminal may output a message inquiring whether to access the second wireless communication system, in operation 470.

In operation 480, the terminal may determine whether a user desires to access the second wireless communication system. If the user desires to access the second wireless communication system, the terminal may connect a radio resource to the second wireless communication system, in operation 490. Conversely, if the user does not desire to access the second wireless communication system, the terminal may enter an idle mode. The idle mode may be a state in which the terminal may use a service, however the terminal is not connected to a wireless communication system.

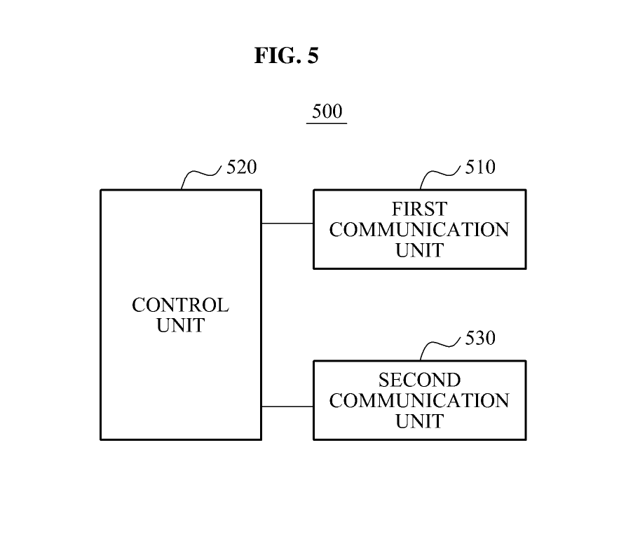

FIG. 5 is a block diagram illustrating a performance reporting apparatus according to an exemplary embodiment. In an exemplary embodiment, the performance reporting apparatus 500 may be the management apparatus B 111.

Referring to FIG. 5, the performance reporting apparatus 500 may include a first communication unit 510, a control unit 520, and a second communication unit 530. In an exemplary embodiment, the first communication unit 510 and the second communication unit 520 may be combined into a single communication unit.

The first communication unit 510 may receive, from a terminal, performance information of a wireless communication service provided by a first wireless communication system. The performance information may include at least one of location information of the terminal, a received field strength, service quality information, and identity information of a relay. The identity information of a relay may be identity information of a relay from which the terminal is currently receiving a service or may be identity information of a preceding relay from which the terminal received a service. In an exemplary embodiment, the first communication unit 510 may receive new performance information received in operation 209 of FIG. 2.

The control unit 520 may check a management apparatus of a first wireless communication system based on the received performance information. The control unit 520 may check a management apparatus of a first wireless communication system through a destination address included in the performance information. In an exemplary embodiment, the control unit 520 may check a target for reporting information about performance, through identity information of a relay included in the performance information. The control unit 520 may recognize that the terminal is moving or that the terminal is not suitably receiving a service, through the received performance information. Accordingly, the control unit 520 may prepare a radio resource to be allocated to the terminal before connection to the terminal. The radio resource to be allocated to the terminal may be a specific slot or frame for a data service. In an exemplary embodiment, the specific slot or frame may be determined prior to or contemporaneous with the preparation of the radio resource. As in operation 209 of FIG. 2, new performance information received through the first communication unit 510 may include information indicating that the terminal 130 is re-connected to the relay 140 or the relay 150. In an exemplary embodiment, if new performance information is received, the control unit 520 may not prepare a radio resource to be allocated to the terminal.

The second communication unit 530 may transmit to a management apparatus of a first wireless communication system the received performance information under the control of the control unit 520. In an exemplary embodiment, the second communication unit 530 may transmit new performance information of operation 211 of FIG. 2 to the first wireless communication is system.

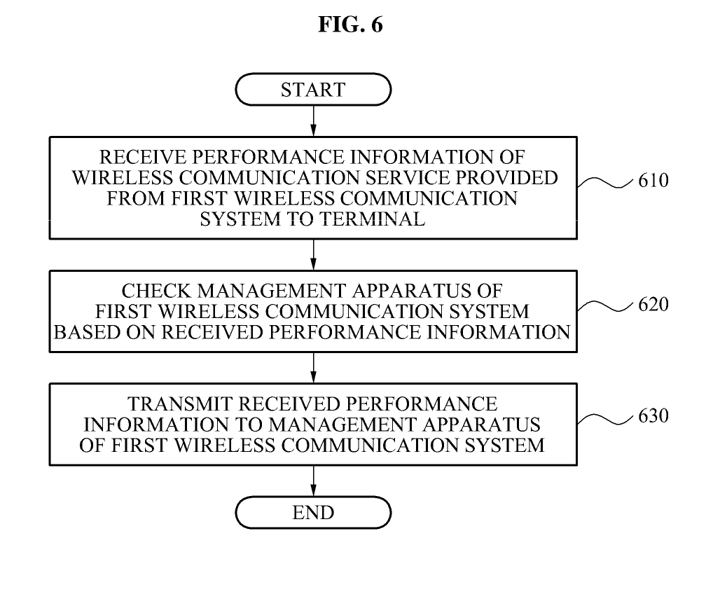

FIG. 6 is a flowchart illustrating a method for performance reporting in a wireless communication system according to an exemplary embodiment. In an exemplary embodiment, the method of FIG. 6 may be performed by the performance reporting apparatus 500 of FIG. 5 or the management apparatus B 111.

In operation 610, a performance reporting apparatus may receive from a terminal that receives a service from the first wireless communication system performance information of a wireless communication service provided by the first wireless communication system to the terminal.

In operation 620, a performance reporting apparatus may check a management apparatus of the first wireless communication system based on the received performance information.

In operation 630, the performance reporting apparatus may transmit the received performance information to the first wireless communication system. In an exemplary embodiment, the first wireless communication system may adjust power of a relay that may be connected to the terminal based on the received performance information. In an exemplary embodiment, the first wireless communication system may update information about a non-service area based on the received performance information.

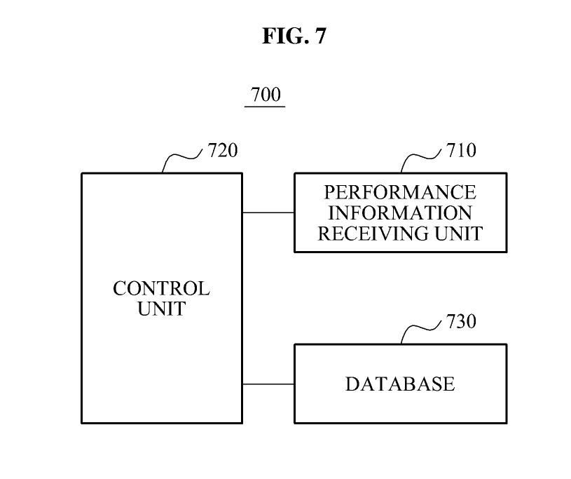

FIG. 7 is a block diagram illustrating a performance receiving apparatus according to an exemplary embodiment. In an exemplary embodiment, the performance receiving apparatus 700 may be the management apparatus A 121.

Referring to FIG. 7, the performance receiving apparatus 700 may include a performance information receiving unit 710, a control unit 720, and a database 730.

The performance information receiving unit 710 may receive performance information of a first wireless communication service from a second wireless communication system.

The control unit 720 may obtain information about a non-service area of a first wireless communication system from the received performance information. Because the performance information includes location information of a terminal and service quality information, the control unit 720 may obtain information about a non-service area from the received performance information. In an exemplary embodiment, the control unit 720 may adjust power of a relay that may be connected to the terminal based on the performance information.

The database 730 may store information about a non-service area of a first wireless communication system. Accordingly, the performance receiving apparatus 700 may build a database for a non-service area within a network. Because performance information includes location information of a terminal and is provided by the terminal that is currently receiving a service, information about a non-service area obtained from the performance information may be utilized.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments.

According to embodiments of the present invention, a channel may be provided, via which information about a wireless network may be shared in an area where different wireless communication systems coexist.

Also, according to exemplary embodiments, a movement of a terminal may be recognized by sharing information about a wireless network in an area where different wireless communication systems coexist.

Also, according to exemplary embodiments, information about a non-service area may be collected by sharing information about a wireless network in an area where different wireless communication systems coexist.

Also, according to exemplary embodiments, a specific action may be taken in real time by effectively collecting information about a non-service area.

Also, according to exemplary embodiments, a database to ensure a stable coverage may be built by collecting information about a non-service area.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for reporting performance in a terminal, the method comprising:
receiving a wireless communication service from a first wireless communication system;
recognizing performance degradation of the wireless communication service provided by the first wireless communication system;
transmitting performance information of the wireless communication service to a second wireless communication system; and
determining whether an accessible relay exists among relays included in the first wireless communication system.

2. The method of claim 1, wherein the receiving of the wireless communication service includes:
obtaining performance information of the wireless communication service provided by the first wireless communication system;
obtaining performance information of a wireless communication service that may be provided by the second wireless communication system; and
storing the performance information of the wireless communication service provided by the first wireless communication system and the performance information of the wireless communication service that may be provided by the second wireless communication system in a memory.

3. The method of claim 1, wherein the recognizing of performance degradation of the wireless communication service comprises recognizing performance degradation of the wireless communication service based on a transmission rate, a received field strength, service quality information of a data service, or combinations thereof, provided by the first wireless communication system.

4. The method of claim 1, wherein the transmitting of the performance information to the second wireless communication system includes:
determining whether a received field strength of a relay of the first wireless communication system is smaller than a specific value;
if the received field strength of the relay of the first wireless communication system is smaller than a specific value, generating performance information including at least one of location information of the terminal, the received field strength, the service quality information, and identity information of the relay; and
transmitting the generated performance information to the second wireless communication system.

5. The method of claim 1, further comprising:
if the accessible relay exists among relays included in the first wireless communication system, generating performance information including identity information of the accessible relay; and
transmitting the performance information including the identity information of the accessible relay to the second wireless communication system.

6. The method of claim 1, further comprising:
if an accessible relay does not exist among relays included in the first wireless communication system, outputting a message inquiring whether to access the second wireless communication system.

7. A method for reporting performance in a first wireless communication system, the method comprising:
receiving performance information of a wireless communication service provided by a second wireless communication system to a terminal, wherein the terminal receives the wireless communication service from the second wireless communication system; and
transmitting the received performance information to the second wireless communication system,
wherein the performance information includes at least one of location information of the terminal, a received field strength, service quality information, and identity information of a relay around the terminal.

8. The method of claim 7, wherein the first wireless communication system or the second wireless communication system provides a data service to the terminal through at least one relay.

9. The method of claim 7 further comprising:
adjusting power of a relay of the second wireless communication system connectable to the terminal based on the performance information.

10. The method of claim 7, further comprising:
updating information about a non-service area of the second wireless communication system based on the performance information.

11. An apparatus to report performance information, the apparatus comprising:
a first performance information obtaining unit to obtain performance information of a wireless communication service provided by a first wireless communication system;
a recognition unit to recognize performance degradation of the wireless communication service provided by the first wireless communication system;
a communication unit to transmit the performance information of the wireless communication service to a second wireless communication system; and
a control unit to determine whether an accessible relay exists among relays included in the first wireless communication system.

12. The apparatus of claim 11, further comprising:
a memory to periodically update the performance information of the wireless communication service provided by the first wireless communication system.

13. The apparatus of claim 11, wherein the recognition unit recognizes performance degradation of the wireless communication service based on a transmission rate, a received field strength, or service quality information of a data service provided by the first wireless communication system.

14. The apparatus of claim 11, wherein if the received field strength of the relay is smaller than a specific value, the control unit generates performance information including at least one of location information of a terminal, a received field strength, service quality information, and identity information of a relay, and controls the communication unit to transmit the generated performance information to the second wireless communication system.

15. The apparatus of claim 11, wherein if the accessible relay exists among relays included in the first wireless communication system, the control unit generates performance information including identity information of the accessible relay and transmits the performance information including the identity information of the accessible relay to the second wireless communication system.

16. The apparatus of claim 11, wherein the control unit outputs a message inquiring whether to access the second wireless communication system if the accessible relay does not exist among relays included in the first wireless communication system.

17. An apparatus to report performance, the apparatus comprising:
a first communication unit to receive performance information of a wireless communication service provided by a first wireless communication system to a terminal, wherein the terminal receives the wireless communication service from the first wireless communication system;
a control unit to check a management apparatus of the first wireless communication system based on the received performance information; and
a second communication unit to transmit the received performance information to a management apparatus of the first wireless communication system.

18. The apparatus of claim 17, wherein the performance information includes at least one of location information of the terminal, a received field strength, service quality information, and identity information of a relay around the terminal.

19. An apparatus to receive performance information, the apparatus comprising:
a performance information receiving unit to receive, from a second wireless communication system, performance information of a wireless communication service provided by a first wireless communication system to a terminal;
a control unit to obtain information about a non-service area of the first wireless communication system based on the received performance information; and
a database to store the information about the non-service area of the first wireless communication system.

20. The apparatus of claim 19, wherein the performance information includes at least one of location information of the terminal, a received field strength, service quality information, and identity information of a relay around the terminal, and
wherein the control unit adjusts power of a relay connectable to the terminal based on the performance information.
